(19) United States
(12) Patent Application Publication
(10) Pub. No.: US 2008/0126837 A1
(43) Pub. Date: May 29, 2008

(54) Method of recovering damage of hard disk having different types of partitions

(75) Inventor: Chih-Wei Chen, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/521,365

(22) Filed: Sep. 15, 2006

(51) Int. Cl. G06F 11/20

(52) U.S. Cl. 714/5; 714/E11.084

(57) ABSTRACT

The present invention discloses a method of recovering damage of a hard disk having different types of partitions. The method can be exercised in an electronic device including several operating hard disks and a backup hard disk, and these operating hard disks are all created an unrecoverable configuration partition and at least one recoverable configuration partition. When any partition of the operating hard disks is damaged, then the electronic device will create the partitions same as those in the damaged operating hard disk into the backup hard disk. If the damaged partition of the damaged hard disk is recoverable, then the data of the damaged recoverable configuration partition in the damaged operating hard disk will be rebuilt into the backup hard disk based on each of the other undamaged operating hard disks, and then the data of the rest undamaged recoverable configuration partitions will be rebuilt into the backup hard disk based on each of other undamaged operating hard disks, and finally the data of the unrecoverable configuration partition will be duplicated from the damaged operating hard disks into the backup hard disk.

### FIELD OF THE INVENTION

The present invention relates to a method of recovering damage of a hard disk having different types of partitions, and more particularly to a method of recovering damage of a hard disk based on different recoverable configuration redundant disk array technologies.

### BACKGROUND OF THE INVENTION

For electronic manufacturers who engage in the production of external storage devices, much emphases are placed on the accessing speed of a hard disk device. As hard disk devices with faster accessing speeds are introduced to the market, manufacturers recognize that a fast and stable hard disk devices cannot be achieved, regardless of the fast speed of the hard disk device, if the safety of storing data is not enhanced. Furthermore, computer devices have become indispensable to our life and work, and computers not only improve our work efficiency, but also greatly lower our burden on processing documents, and thus we substantially rely on the data stored in a hard disk of the computer device. Therefore, potential dangers should be taken into consideration. Since we rely heavily on the data stored in such hard disk devices, irreversible damages may occur, if such hard disk devices fail or have a bad track or sector.

Related manufacturers provide a redundant array of independent disks (RAID) using a method of combining several hard disks to provide a high performance and redundant function for standardizing and categorizing the high transmission rate of the redundant array of inexpensive disk (RAID) technology, so that a plurality of disk drivers can transmit data simultaneously, and the disk driver itself could be a whole set of disk drivers. The RAID technology can expedite a single disk driver by several tens of times or even hundreds of times in compliance with a high-speed central processing unit (CPU) of a computer.

The RAID technology further includes a fault-tolerance function (not including the cyclic redundancy check, CRC) which is not provided by a general disk driver for writing data on a disk, and the RAID technology is established on the hardware fault-tolerance function of each disk driver, and thus can provide a higher safety for the data storage.

Based on different requirements, the RAID technology includes:

1. RAID 0 Technology:

The RAID 0 is also known as “striping” that uses two or more hard disks, and the usable memory space of each hard disk is divided into chunks, and a chunk represents a combination of sectors in the hard disk, and all data written into the disk array are divided into chunks and written sequentially into each disk, and these chunks in the array look like a stripe. For instance, if 12 KB of data is written into dual disks, and a chunk in the array has a size of 4 KB, then the data is divided into three 4 KB chunks and written into the disk as follows: The first 4K of data is written into a first chunk of a first hard disk; the second 4K of data is written into a first chunk of a second disk, and the last 4K of data is written into a second chunk of the first disk.

Compared with a single hard disk, the RAID 0 technology has the following advantages:

a. The RAID 0 technology provides a larger storage space for storing larger data files than the single hard disk.

b. The RAID 0 technology provides a better write-in performance, since the I/O operations of the array of the RAID 0 technology are evenly allocated to all hard disks in the array.

c. The RAID 0 technology wastes no space, since the spaces of all hard disks are used for storing data;

d. The RAID 0 technology is relatively unreliable, and each disk in the array must work properly to maintain the operation of the RAID 0 technology.

e. If any one of N hard disks with the RAID 0 technology fails, the whole data cannot be used even though only 1/N of the data is damaged.

2. RAID 1 Technology:

The RAID 1 technology is also known as mirroring that uses two (or even more) identical hard disks, so that all data are written into the two hard disks at the same time. When the RAID 1 technology writes a data into a hard disk, a computer system duplicates two copies of data, such that one copy of data is written into a hard disk, and another copy of data is written into another hard disk. On the contrary, when the RAID 1 technology reads a data, only the data in one of the hard disks is read.

Compared with a single hard disk, the RAID 1 technology has the following advantages:

a. The RAID 1 technology provides a more redundant reliability, and even one of the hard disks fails, users still can access data.

b. The RAID 1 technology provides a better read performance and read data separately from two hard disks, and thus sharing the burden of I/O operations of the single hard disk.

c. The maximum space of the array cannot exceed the maximum hard disk capacity in the array.

d. The write-in performance of the RAID 1 technology becomes slower, because updated data is maintained in the two hard disks. When a data is written, two hard disks are operating at the same time, and thus slowing down the overall write-in performance of the array.

e. The RAID 1 technology has a lower cost-effectiveness, because one copy of data is stored in two hard disks at the same time, and thus the cost of the RAID 1 technology is at least twice as much as the cost of the single hard disk.

3. RAID 2 Technology:

The RAID 2 technology is also called an error correcting Hamming code disk array. In the disk array, a first disk, a second disk, a fourth disk . . . and a 2 n^{th} disk are detecting disks for detecting and correcting errors. For instance, seven disks are used in the RAID 2 technology, wherein the first, second, and fourth disks are detecting disks, and the rest of disks are used for storing data. Thus, the more disks used, the less is the number of detecting disks. The RAID 2 technology is very useful for the output of huge data. On the other hand, RAID 2 is rarely used in applications with an output of a small number of data.

4. RAID 3 Technology:

The RAID 3 technology requires at least three hard disks, and the data will be magnetized into stripes of the same size and stored in different hard disks, and one of the hard disks is specified for storing a parity which is calculated from the data stored in the hard disks. If one of the hard disks fails, users can change such hard disk, and the computer system will rebuild the hard disk by other data and store the data back into an updated hard disk.

5. RAID 5 Technology:

The RAID 5 technology has the advantage of attempting to integrate the RAID 0 technology and the RAID 1 technology, and also overcomes existing shortcomings. The RAID 5 array comprises a plurality of hard disks (at least three or more hard disks of the same size), and each hard disk is divided into several chunks, such that the data can be written sequentially. Unlike the RAID 0 technology, not every chunk is used for storing data. On the contrary, only the n^{th} chuck of a disk having n hard disks in an array will be used for storing a parity check code. At present, a system includes a plurality of hard disks, and each hard disk stores data of different levels of importance. The more important data is processed and backed up by the RAID 1 or RAID 5 technology, and the less important data is processed and backed up by the RAID 0 technology. However, if the system having a very limited number of hard disks that are insufficient for the backup and processing or the system only uses one of the foregoing RAID technologies to process and back up all data in each hard disk of the system, it cannot concurrently give considerations to disk capacity allocation and disk safety, and it will create many limitations to the backup of the disks. Thus, finding a method of recovering damage of hard disk having different types of partitions to overcome the issue of a limited number of hard disks and recover the data if one of the hard disks fails in order to maintain the normal operation of the system demands immediate attentions and feasible solutions.

### SUMMARY OF THE INVENTION

In view of the foregoing shortcomings of the prior art, the inventor of the present invention based on years of experience to conduct extensive researches and experiments and finally invented a method of recovering damage of hard disk having different types of partitions, so as to effectively give considerations to both disk capacity allocation and disk safety and maintain a balance between the data with different levels of importance.

Therefore, it is a primary objective of the present invention to overcome the foregoing shortcomings by providing a method of recovering damage of hard disk having different types of partitions. The method implements in an electronic device comprising a plurality of operating hard disks and a backup hard disk, and the electronic device creates an unrecoverable configuration partition separately on these operating hard disks according to an unrecoverable configuration redundant disk array technology, and creates at least one recoverable configuration partition according to at least one recoverable configuration redundant disk array technology. If the electronic device determines that any recoverable configuration partition of an operating hard disk is damaged, the electronic device will create an unrecoverable configuration backup partition and a number of recoverable configuration backup partitions equal to the number of the recoverable configuration partition in the backup hard disk according to the unrecoverable configuration partition and each recoverable configuration partition in the damaged operating hard disk, and duplicate the data of the unrecoverable configuration partition of the damaged operating hard disk into the unrecoverable configuration backup partition, and will rebuild the data of each recoverable configuration partition of the damaged operating hard disk into each recoverable configuration backup partition according to different recoverable configuration redundant disk array technologies.

The above and other objects, features and advantages of the present invention will become apparent from the following detailed description taken with the accompanying drawings.

### BRIEF DESCRIPTION OF THE DRAWINGS

FIG. 1 is a schematic block diagram of a first preferred embodiment of the present invention;

FIG. 2 is a flow chart of a first preferred embodiment of the present invention;

FIG. 3 is another flow chart of a first preferred embodiment of the present invention;

FIG. 4 is a schematic block diagram of a second preferred embodiment of the present invention;

FIG. 5 is a flow chart of a second preferred embodiment of the present invention;

FIG. 6 is another flow chart of a second preferred embodiment of the present invention;

FIG. 7 is a schematic block diagram of a third preferred embodiment of the present invention; and

FIG. 8 is a flow chart of a third preferred embodiment of the present invention.

### DETAILED DESCRIPTION OF THE PREFERRED EMBODIMENTS

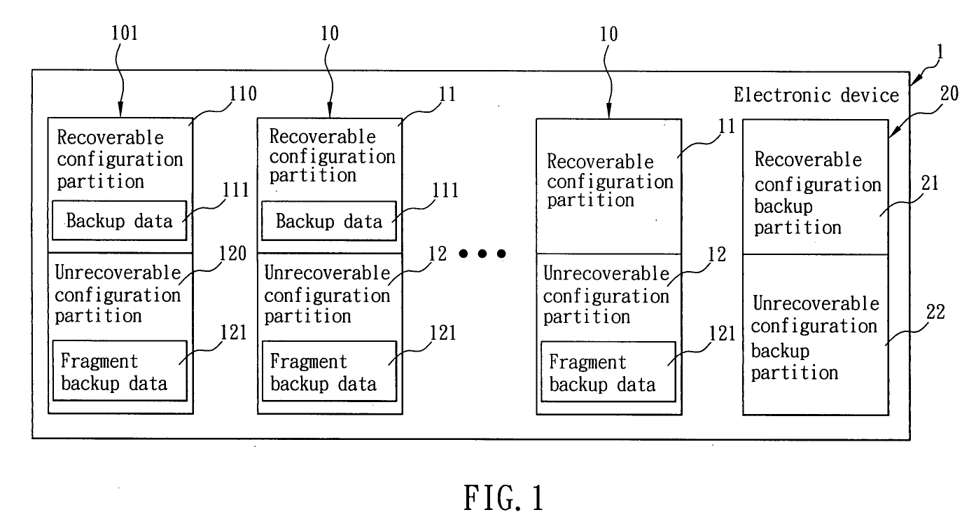

Referring to FIG. 1 for a method of recovering damage of hard disk having different types of partitions in accordance with a preferred embodiment of the present invention, the method which is implemented in an electronic device 1 (such as a computer or a server), and the electronic device 1 includes a plurality of operating hard disks (HDD) 10 and a backup hard disk (backup HDD) 20, and the electronic device 1 creates an unrecoverable configuration partition 12 (such as a disk partition) in the operating hard disks 10 according to an unrecoverable configuration redundant disk array technology (such as RAID 0 technology), such that if the data in an unrecoverable configuration partition 12 is lost, the data in the rest of the unrecoverable configuration partitions 12 cannot provide complete data for the recovery, and the electronic device 1 further creates a recoverable configuration partition 11 (such as a disk partition) in the operating hard disks 10 according to at least one recoverable configuration redundant disk array technology (such as RAID 1 technology or RAID 5 technology), such that if the data in one of the recoverable configuration partitions 11 is lost, the data of the rest of each recoverable configuration partition 11 can be provided for recovering the complete data.

In FIG. 1, if any partition of the operating hard disk 101 is damaged, then the electronic device 1 will create an unrecoverable configuration backup partition 22 in the backup hard disk 20 according to the unrecoverable configuration partition 120 of the damaged operating hard disk 101, and will create a recoverable configuration backup partition 21 in the backup hard disk 20 according to these recoverable configuration partition 110 of the damaged operating hard disk 101, and the electronic device 1 will determine whether or not the damaged partition in the damaged operating hard disk 101 is recoverable, if the damaged partition in the damaged operating hard disk 101 is recoverable, then the electronic device 1 will rebuild the data of the damaged recoverable configuration partition 110 and the data of the rest of undamaged recoverable configuration partitions 110 of the damaged operating hard disk 101 from each of other undamaged operating hard disks 10 into the backup hard disk 20 according to different recoverable configuration redundant disk array technologies, and on the other hand, the electronic device 1 will duplicate the data of the unrecoverable configuration partition 120 from said damaged operating hard disk 101 into the back hard disk 20. Thus, if any operating hard disk 101 fails (even if each of the recoverable configuration partitions 110 fails), the data of each recoverable configuration partition 11 in the rest of the operating hard disks 10 still can be used, and the damaged operating hard disk 101 can be removed.

In FIG. 1, if the damaged partition in the damaged operating hard disk 101 is unrecoverable, the electronic device 1 will create an unrecoverable configuration backup partition 22 in the backup hard disk 20 according to the unrecoverable configuration partition 120 of the damaged operating hard disk 101, and will create at least one recoverable configuration backup partition 21 in the backup hard disk 20 according to each recoverable configuration partition 110 of the damaged operating hard disk 101, and then will respectively rebuild the data of each recoverable configuration partition 110 of the damaged operating hard disk 101 into each recoverable configuration backup partition according to different recoverable configuration redundant disk array technologies. Since each unrecoverable configuration partition 120 is damaged, the data therein is lost, and the data of the rest of the unrecoverable configuration partitions 120 cannot recover the whole data, therefore the electronic device 1 only rebuilds the data of each recoverable configuration partition 110 into each recoverable configuration backup partition 21 according to different recoverable configuration redundant disk array technologies, and labels the unrecoverable configuration partition 120 of the damaged operating hard disk 101, or removes the damaged operating hard disk 101, so that the unrecoverable configuration partition 120 cannot be used anymore.

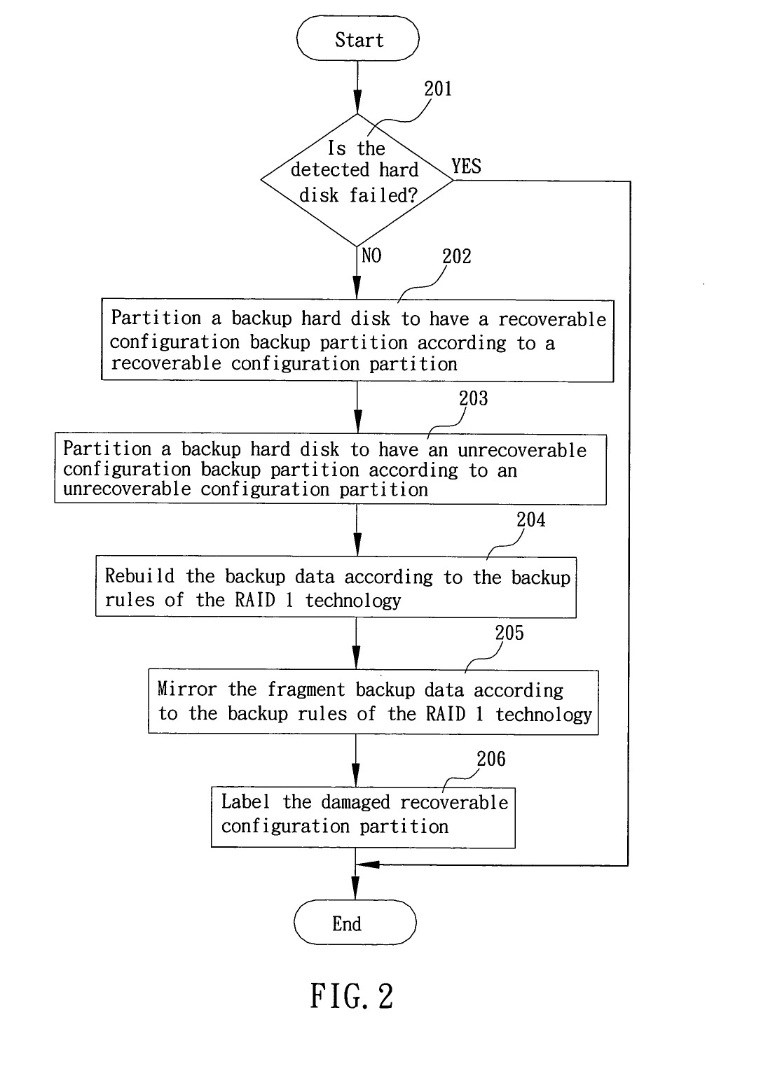

For instance, in a first preferred embodiment as shown in FIG. 1, each operating hard disk 10 only has a recoverable configuration partition 11 and an unrecoverable configuration partition 12, wherein one of the recoverable configuration redundant disk array technologies could be the RAID 1 technology and the recoverable configuration partitions 11 of any two operating hard disks 10 contain the same backup data 111, and each backup data 111 could be a first complete data, and the unrecoverable configuration redundant disk array technology could be the RAID 0 technology, and the unrecoverable configuration partition 12 of each operating hard disk 10 contains a fragment backup data 121, and the fragment backup data 121 can be combined into a complete second data. If a recoverable configuration partition 110 in an operating hard disk 101 is damaged and its backup data 111 cannot be used, the electronic device 1 will process the following procedure as shown in FIG. 2:

(Step 201) detecting whether or not the backup hard disk 20 fails; if yes, then end this procedure, or else go to Step 202;

(Step 202) partitioning the backup hard disk 20 into partitions, one of which having the same configuration according to the recoverable configuration partition 110 of the damaged operating hard disk 101, such that the backup hard disk 20 has a recoverable configuration backup partition 21;

(Step 203) partitioning the backup hard disk 20 into partitions, one of which having the same configuration according to the unrecoverable configuration partition 120 of the damaged operating hard disk 101, such that the backup hard disk 20 has an unrecoverable configuration backup partition 22;

(Step 204) rebuilding the backup data 111 from the recoverable configuration partition 11 of the rest having the backup data 111 according to the rebuilding rules of the RAID 1 technology into the recoverable configuration backup partition 21;

(Step 205) mirroring the fragment backup data 121 of the unrecoverable configuration partition 120 of the damaged operating hard disk 101 according to the backup rules of the RAID 1 technology into the unrecoverable configuration backup partition 22; and

(Step 206) labeling the recoverable configuration partition 110 of the damaged operating hard disk 101, so that the recoverable configuration partition 110 cannot be used anymore.

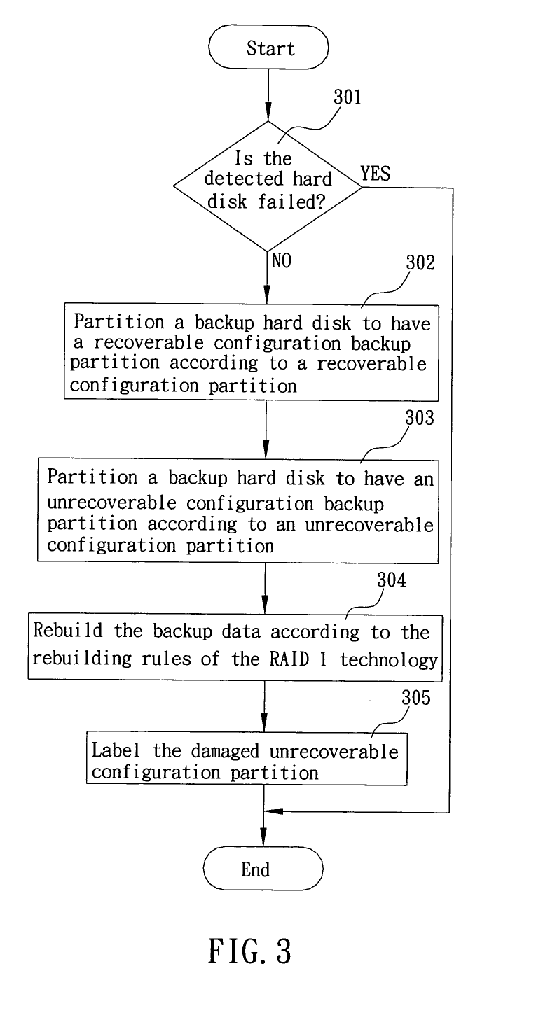

If an unrecoverable configuration partition 120 of the operating hard disk 101 is damaged and the fragment backup data 121 cannot be used, the electronic device 1 will process the following procedure as shown in FIG. 3:

(Step 301) detecting whether or not the backup hard disk 20 fails; if yes, then end this procedure, or else go to Step 302;

(Step 302) partitioning the backup hard disk 20 into partitions, one of which having the same configuration according to the recoverable configuration partition 110 of the damaged operating hard disk 101, such that the backup hard disk 20 has a recoverable configuration backup partition 21;

(Step 303) partitioning the backup hard disk 20 into partitions, one of which having the same configuration according to the unrecoverable configuration partition 120 of the damaged operating hard disk 101, such that the backup hard disk 20 has an unrecoverable configuration backup partition 22;

(Step 304) rebuilding the backup data 111 from the recoverable configuration partition 11 of the rest having the backup data 111 according to the rebuilding rules of the RAID 1 technology into the recoverable configuration backup partition 21; and

(Step 305) labeling the unrecoverable configuration partition 120 of the damaged operating hard disk 101, such that the unrecoverable configuration partition 120 cannot be used anymore.

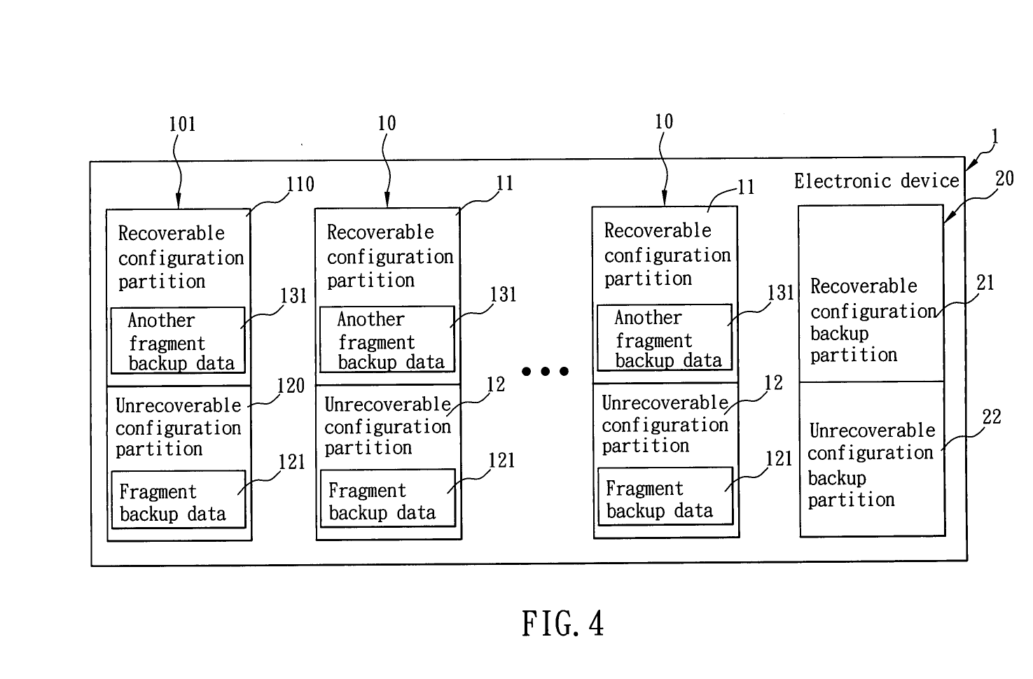

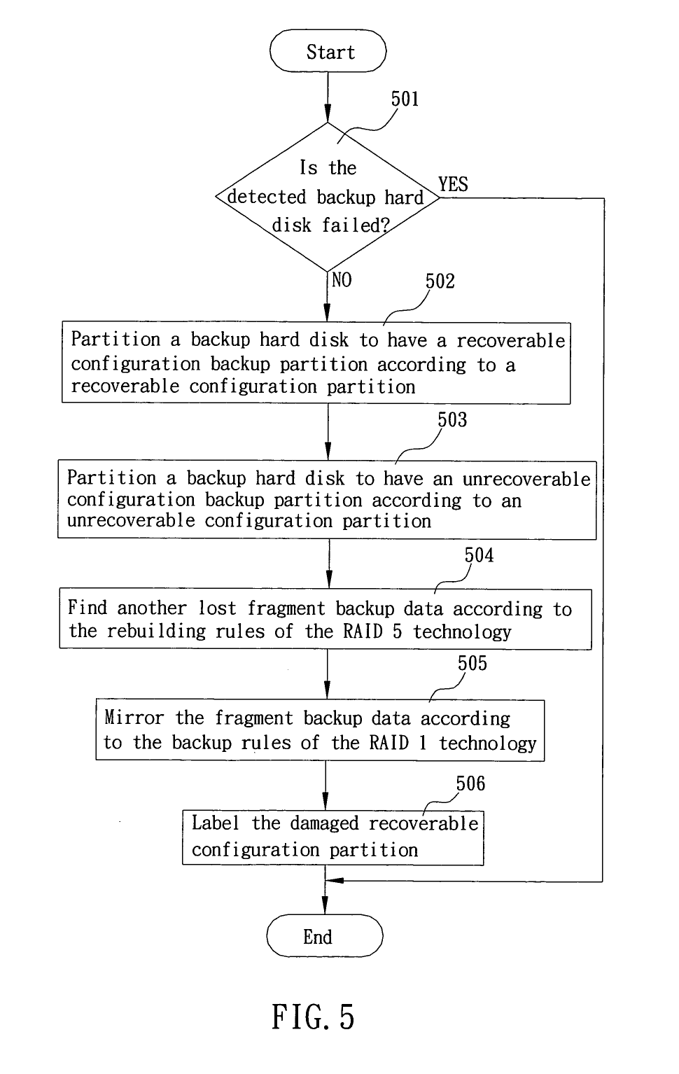

In a second preferred embodiment of the present invention as shown in FIG. 4, each operating hard disk 10 only has a recoverable configuration partition 11 and an unrecoverable configuration partition 12, and the recoverable configuration redundant disk array technology is the RAID 5 technology, and recoverable configuration partition 11 of each operating hard disk 10 has another fragment backup data 131, and each of such fragment backup data 131 can be combined into a third complete data, and such fragment backup data 131 can be used for finding any other lost fragment backup data 131. The unrecoverable configuration redundant disk array technology is the RAID 0 technology, and the unrecoverable configuration partition 12 of each operating hard disk 10 has a fragment backup data 121, and the fragment backup data 121 can be combined into a second complete data. If a recoverable configuration partition 110 of an operating hard disk 101 is damaged and another fragment backup data 131 cannot be used, the electronic device 1 will process the following procedure as shown in FIG. 5:

(Step 501) detecting whether or not the backup hard disk 20 fails; if yes, then end this procedure, or else, go to Step 502;

(Step 502) partitioning the backup hard disk 20 into partitions, one of which having the same configuration according to the recoverable configuration partition 110 of the damaged operating hard disk 101, such that the backup hard disk 20 has a recoverable configuration backup partition 21;

(Step 503) partitioning the backup hard disk 20 into partitions, one of which having the same configuration according to the unrecoverable configuration partition 120 of the damaged operating hard disk 101, such that the backup hard disk 20 has an unrecoverable configuration backup partition 22;

(Step 504) using another backup data of each of the rest recoverable configuration partitions 11 to find other lost fragment backup data 131 according to the rebuilding rules of the RAID 5 technology, and backing up the lost fragment backup data 131 into the recoverable configuration backup partition 21;

(Step 505) rebuilding the fragment backup data 121 from the unrecoverable configuration partition 120 of the damaged operating hard disk 101 according to the backup rules of the RAID 1 technology, such that the fragment backup data 121 is rebuilt into the unrecoverable configuration backup partition 22; and

(Step 506) labeling the recoverable configuration partition 110 of the damaged operating hard disk 101, such that the recoverable configuration partition 110 cannot be used anymore.

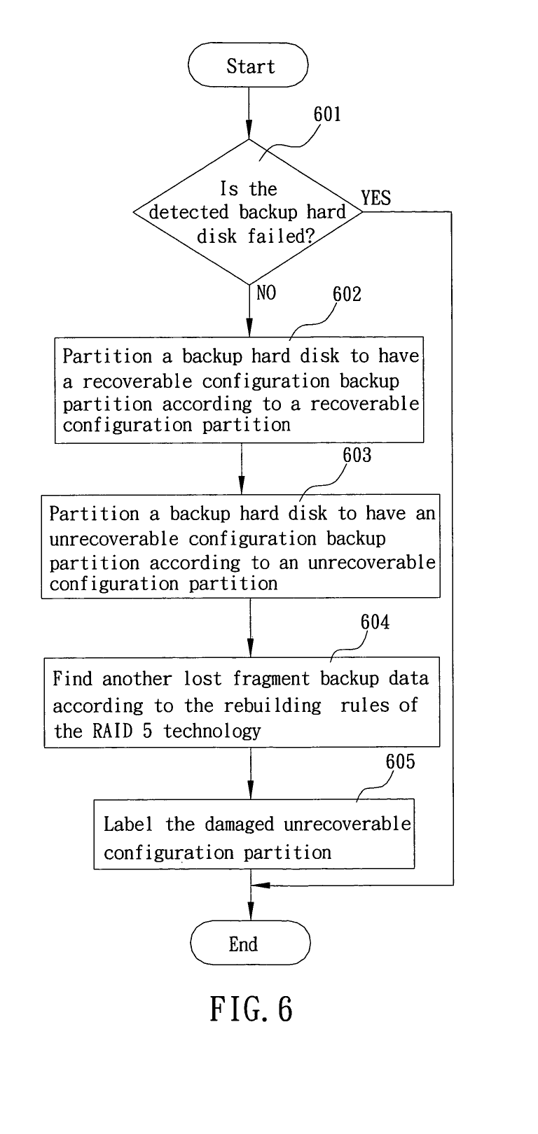

If an unrecoverable configuration partition 120 of the damaged operating hard disk 101 is damaged and the fragment backup data 121 cannot be used, the electronic device 1 will process the following procedure as shown in FIG. 6:

(Step 601) detecting whether or not the backup hard disk 20 fails; if yes, then end this procedure, or else go to Step 602;

(Step 602) partitioning the backup hard disk 20 into partitions, one of which having the same configuration according to the recoverable configuration partition 110 of the damaged operating hard disk 101, such that the backup hard disk 20 has a recoverable configuration backup partition 21;

(Step 603) partitioning the backup hard disk 20 into partitions, one of which having the same configurations according to the unrecoverable configuration partition 120 of the damaged operating hard disk 101, such that the backup hard disk 20 has an unrecoverable configuration backup partition 22;

(Step 604) finding each of the lost fragment backup data 131 from the rest according to the rebuilding rules of the RAID 5 technology and backing up the fragment backup data 131 into the recoverable configuration backup partition 21; and

(Step 605) labeling the unrecoverable configuration partition 120 of the damaged operating hard disk 101, such that the unrecoverable configuration partition 120 cannot be used anymore.

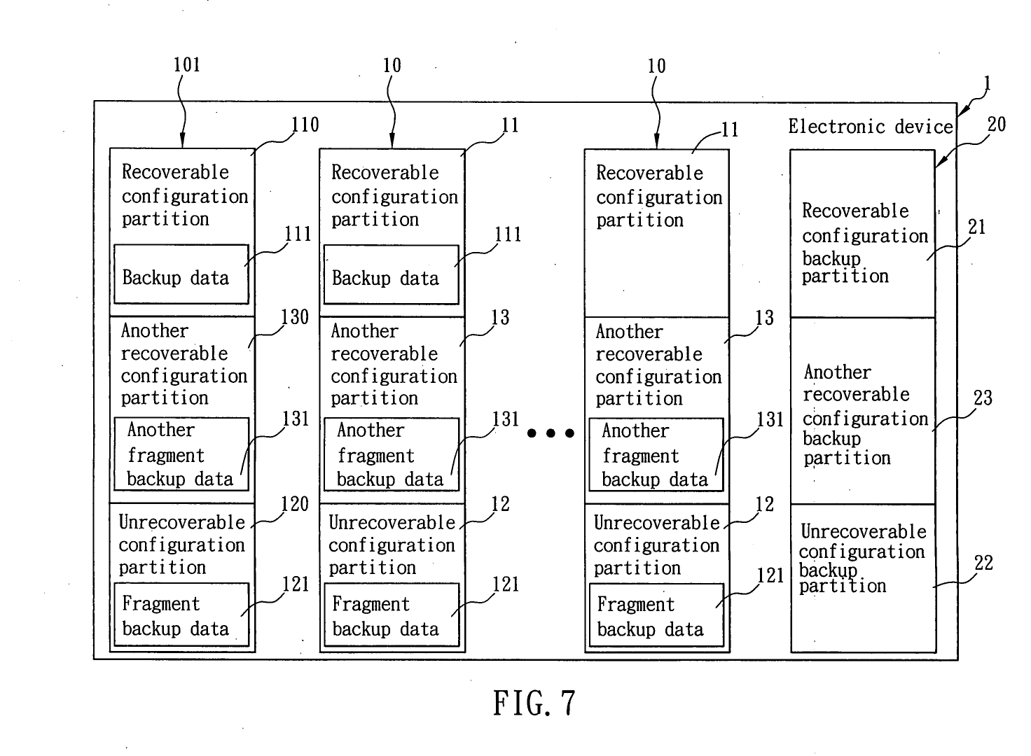

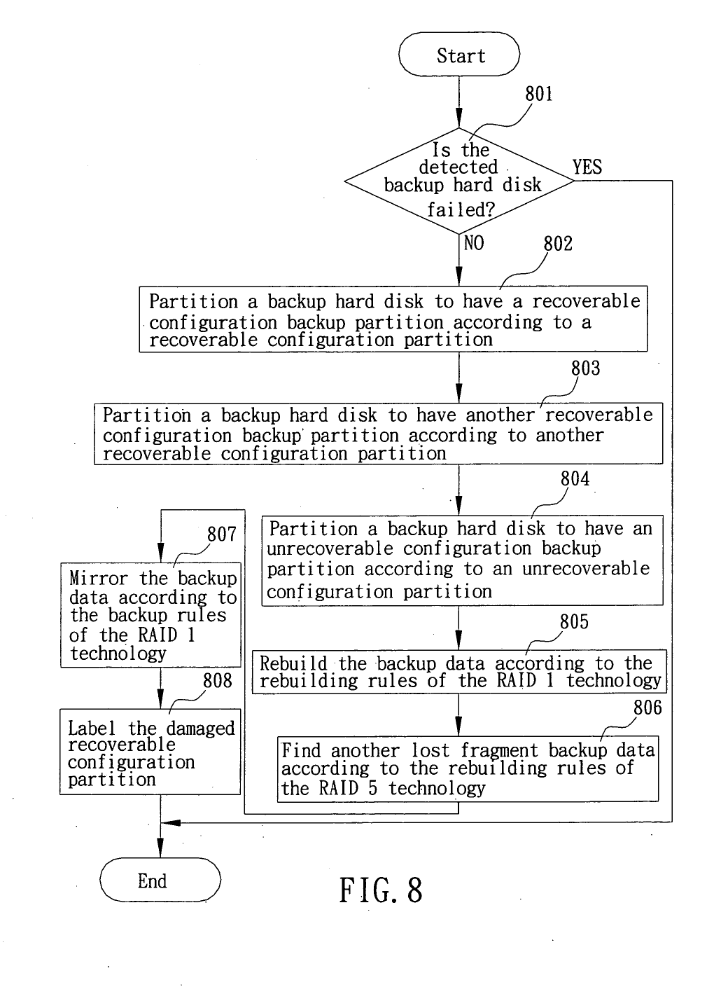

In a third preferred embodiment of the present invention as shown in FIG. 7, each operating hard disk 10 follows another recoverable configuration redundant disk array technology, such that each operating hard disk 10 has a recoverable configuration partition 11, another recoverable configuration partition 13 (such as a disk partition) and an unrecoverable configuration partition 12, and the recoverable configuration redundant disk array technology is the RAID 1 technology, and a recoverable configuration partition 11 of any two operating hard disks 10 has the same backup data 111, and each backup data 111 could be the first complete data, and the unrecoverable configuration redundant disk array technology could be the RAID 0 technology, and the unrecoverable configuration partition 12 of each operating hard disk 10 has a fragment backup data 121, and the fragment backup data 121 can be combined into a second complete data, and such recoverable configuration redundant disk array technology could be the RAID 5 technology, and another recoverable configuration partition 13 of each operating hard disk 10 has another fragment backup data 131, and each of such fragment backup data 131 can be combined into a third complete data, and each of such fragment backup data 131 can be used for finding any other lost fragment backup data 131. If a recoverable configuration partition 110, 130 of an operating hard disk 101 is damaged and the backup data 111 or another fragment backup data 131 cannot be used, the electronic device 1 will process the following procedure as shown in FIG. 8:

(Step 801) detecting whether or not the backup hard disk 20 fails; if yes, then end this procedure, or else go to Step 802;

(Step 802) partitioning the backup hard disk 20 into partitions, one of which having the same configuration according to the recoverable configuration partition 110 of the damaged operating hard disk 101, such that the backup hard disk 20 has a recoverable configuration backup partition 21;

(Step 803) partitioning the backup hard disk 20 into partitions, one of which having the same configuration according to another recoverable configuration partition 130 of the damaged operating hard disk 101, such that the backup hard disk 20 has another recoverable configuration backup partition 23 (refer to FIG. 7);

(Step 804) partitioning the backup hard disk 20 into partitions, one of which having the same configuration according to an unrecoverable configuration partition 120 of the damaged operating hard disk 101, such that the backup hard disk 20 has an unrecoverable configuration backup partition 22;

(Step 805) rebuilding the backup data 111 from the recoverable configuration partition 11 of the rest of operating hard disks 10 according to the rebuilding rules of the RAID 1, such that the backup data 111 is rebuilt into the recoverable configuration backup partition 21;

(Step 806) finding another fragment backup data 131 from each other recoverable configuration partition 13 of the rest of operating hard disks 10 according to the rebuilding rules of the RAID 5, and backing up such fragment backup data 131 into the recoverable configuration backup partition 23;

(Step 807) rebuilding the fragment backup data 121 from the unrecoverable configuration partition 120 of the damaged operating hard disk 101 according to the backup rules of the RAID 1, such that the fragment backup data 121 is rebuilt into the unrecoverable configuration backup partition 22; and

(Step 808) labeling the recoverable configuration partition 110 of the damaged operating hard disk 101, such that the recoverable configuration partition 110 cannot be used anymore.

While the invention herein disclosed has been described by means of specific embodiments, numerous modifications and variations could be made thereto by those skilled in the art without departing from the scope and spirit of the invention set forth in the claims.

What is claimed is:

1. A method of recovering damage of a hard disk having different types of partitions, which is implemented in an electronic device comprising a plurality of operating hard disks and a backup hard disk wherein said each operating hard disk has an unrecoverable configuration partition and at least one recoverable configuration partition, comprising the steps of:
when any partition of said operating hard disks is damaged, creating partitions same as those in said damaged operating hard disk in said backup hard disk;
determining said damaged partition in said damaged operating hard disk is recoverable, and rebuilding the data of said damaged recoverable configuration partition of said damaged operating hard disk from each of other undamaged operating hard disks into said backup hard disk;
rebuilding the data of the rest of undamaged recoverable configuration partitions of said damaged operating hard disk from each of said other undamaged operating hard disks into said backup hard disk; and
duplicating the data of said unrecoverable configuration partition from said damaged operating hard disk into said backup hard disk.

2. The method of claim 1 wherein, when said damaged partition of said damaged operating hard disk is not a recoverable configuration partition, further comprises the step of:
rebuilding the data of said recoverable configuration partition of said damaged operating hard disk from said other undamaged operating hard disk into said backup hard disk.

3. The method of claim 1, wherein said unrecoverable configuration partition is recreated according to the rules of an unrecoverable configuration redundant disk array technology, and said recoverable configuration partition is created according to the rules of a recoverable configuration redundant disk array technology.

4. The method of claim 3, wherein said recoverable configuration redundant disk array technology is a RAID 1 technology or a RAID 5 technology.

5. The method of claim 3, wherein said unrecoverable configuration redundant disk array technology is a RAID 0 technology.

6. The method of claim 1 wherein, when a damaged partition occurs in said damaged operating, further comprises the step of labeling said damaged operating hard disk.
